(19) United States
(12) Patent Application Publication
(10) Pub. No.: US 2009/0087152 A1
(43) Pub. Date: Apr. 2, 2009

(54) Optical Cable, Arrangement for Connecting a Multiplicity of Optical Waveguides, and Method for Manufacturing an Optical Cable

(76) Inventors: Karl Heinz Wich, Marktrodach (DE); Swen Tischer, Neustadt bei Coburg (DE)

Correspondence Address: Corning Cable Systems;c/o Corning Incorporated, SP-TI-3-1, Corning, NY, 14831, US

(21) Appl. No.: 11/795,461

(22) PCT Filed: Jan. 13, 2006
(86) PCT No.: PCT/EP2006/000288

§ 371 Date: Aug. 6, 2008

(30) Foreign Application Priority Data
Jan. 17, 2005 (DE) 102005002186.7

(51) Int. Cl. G02B 6/26

(52) U.S. Cl. 385/102

(57) ABSTRACT

An optical cable which occupies little space and is highly flexible irrespective of the bending direction has a cable sheath and one and only one core, which is surrounded by the cable sheath. The one and only one core contains a plurality of optical waveguides. The optical cable and the core each have a round cross section. The optical cable is designed to produce an optical connection between further optical waveguides. Furthermore, an arrangement for connection of a multiplicity of optical waveguides has an array of connections. The ends of the optical cable can be connected to in each case two of the connections, so that the connections between a multiplicity of further optical waveguides are configurable. A method for production of the optical cable includes the prefabrication of a multi-fiber cable for use in a jumper panel.

### FIELD OF THE INVENTION

The invention relates to an optical cable. The invention also relates to an arrangement and to a method for connection of a multiplicity of optical waveguides. The arrangement and the method relate in particular to the wiring of a jumper panel in a distribution cabinet.

### BACKGROUND OF THE INVENTION

A distribution cabinet is, for example, connected via first wiring to a communication network and via second wiring to peripherals with connecting sockets for terminals. The terminals, for example computers, can be connected via connecting cables to the connecting sockets on the peripherals. Jumper panels, in particular, are accommodated in the distribution cabinet. Jumper panels are also referred to as patch panels.

A jumper panel is used for configuration of the connections between the communication network and the peripherals. The jumper panel normally has an array of connections, which are arranged on a front panel. Each connecting socket on the peripheral has an associated connection on the front panel of the jumper panel. A plurality of these connections are normally associated with the communication network.

The optical waveguides in an optical cable in the first wiring or in the second wiring are separated in the distribution cabinet, are supplied from the rear face of the front panel to the connections on the jumper panel, and are fixed in the connections. Two of the connections are each connected to one another via a jumper cable on the front face of the front panel.

Already known jumper cables for optical cable networks are in the form of single fiber cables (SFC) or ribbon cables (RC).

A jumper cable in the form of a single fiber cable contains only a single optical waveguide, which is surrounded by a protective cable sheath. Only in each case one optical waveguide in the first wiring and one optical waveguide in the second wiring can be connected to one another via a single fiber cable. The wiring for a jumper panel which is connected to a large number of waveguides in the first and the second wiring thus requires a large number of jumper cables. Since the cable sheath of each single fiber cable has a certain thickness, a considerable amount of space is required for the large number of jumper cables. If the thickness of the cable sheath is reduced in order to reduce the space required by a jumper cable, it must be accepted that the jumper cable will have less tensile strength.

A jumper cable in the form of a ribbon cable contains a plurality of optical waveguides, which are arranged in a row alongside one another to form a ribbon. A plurality of such ribbons can also be arranged to form a stack. Each of these optical waveguides is surrounded by a sleeve. The sleeves on adjacent optical waveguides are connected to one another, for example by adhesive bonding or fusing. A plurality of optical waveguides in the first wiring and in the second wiring can be connected to one another via a ribbon cable. Owing to the particular arrangement of the optical waveguides, a ribbon cable has a preferred bending direction, however. As soon as the jumper cable is connected to a first of the connections on the jumper panel, the preferred bending direction with respect to the position of the array of connections is fixed. This therefore restricts the routing options for a ribbon cable on the front face of the front panel. During prefabrication of a ribbon cable, the optical waveguides are first of all separated by separating the sleeves which are adhesively bonded to form a ribbon. The optical waveguides are then exposed by individually removing the sleeves. It is therefore more difficult to prefabricate a ribbon cable than to prefabricate a single fiber cable.

### SUMMARY OF THE INVENTION

The object of the invention is accordingly to provide an optical cable which is highly flexible without any preferred bending direction, and which can be prefabricated easily. A further object of the invention is to provide an arrangement and a method for connection of a multiplicity of optical waveguides and, in particular, for space-saving wiring of a jumper panel.

The optical cable comprises a cable sheath and one and only one core, which is surrounded by the cable sheath. The one and only one core contains a plurality of first optical waveguides. The optical cable and the core each have a round cross section. The optical cable is designed to produce an optical connection between further optical waveguides.

A centrally arranged core, which contains a plurality of first optical waveguides, in the optical cable is surrounded by a protective cable sheath. The wiring of a jumper panel with a large number of these optical cables therefore requires less space than the wiring of the same jumper panel with single fiber cables. The flexibility of the optical cable is independent of the bending direction. The minimum bending radius is thus the same for any bending direction. The optical cable can be prefabricated more easily than a ribbon cable.

The core preferably comprises a core sleeve, which surrounds the first optical waveguides and is surrounded by the cable sheath. The core sleeve has a low elongation at tear, so that it can be removed (pulled off) quickly and without any tools, even over relatively long lengths, in order to expose the first optical waveguides. The core sleeve may be composed of a polymer filled with an additive, containing ethyl-vinyl acetate, polyvinyl chloride or a thermoplastic elastomer (TPE).

The core sleeve preferably surrounds a dry internal area, that is to say in particular it is free of any thixotropic filling compound. Since, in consequence, no filling compound can emerge during prefabrication, the optical cable is very highly suitable for use as an inner cable.

The first optical waveguides are preferably longer than the cable sheath. It is thus impossible for excessive mechanical stresses to occur in the optical waveguides during bending or rotation. The optical cable thus has a small minimum bending radius. It is also feasible for the first optical waveguides to be twisted (i.e., stranded together).

A first strain-relief arrangement is preferably formed between the core or core sleeve and the cable sheath. The first strain-relief arrangement preferably has a plurality of strands, which are arranged distributed uniformly around the core. The first strain-relief arrangement is designed to absorb tensile stresses introduced at the end of the cable.

At its first and/or second end, the optical cable preferably has a connecting apparatus, which is preferably attached to the first strain-relief arrangement.

A first variant of the connecting apparatus comprises a first plug connection element, which is attached to the first strain-relief arrangement and in which at least two of the first optical waveguides are fixed. One of the first optical waveguides is in this case fixed, for example, in a respective small guide tube composed of metal or ceramic.

A second variant of the connecting apparatus comprises a connecting element which is attached to the first strain-relief arrangement, a plurality of second optical waveguides which are each optically coupled to one of the first optical waveguides, and a plurality of second strain-relief arrangements, which each surround one of the second optical waveguides and are attached to the connecting element. The second optical waveguides can each be welded (i.e., fusion spliced) to said one of the first optical waveguides.

The first connecting apparatus may have a plurality of second plug connection elements, each of which is attached at one of the second strain-relief arrangements and is designed to produce one and only one plug-in optical connection. That of the second waveguides which is in each case surrounded by one of the second strain-relief arrangements is fixed at the respective one of the second plug connection elements.

The total number of first optical waveguides is preferably 2 to 24. The space required for the optical cable which is lower in comparison to conventional jumper cables, when wiring up a jumper panel has an effect to an ever greater extent as the number of first optical waveguides surrounded by the cable sheath increases.

At least one of the first optical waveguides can be designed to carry one and only one optical mode. At least one of the first optical waveguides may, however, also be designed to carry a plurality of optical modes.

If the total number of first optical waveguides is 2 to 12, the optical cable has, in particular, an external diameter of up to 3.0 mm. If the total number of first optical waveguides is 13 to 24, the optical cable has, in particular, an external diameter of up to 3.5 mm. These values correspond approximately to the diameter of a single fiber cable. However, an optical cable according to the invention can be used for carrying a greater number of optical waveguides than is possible with a single fiber cable.

The arrangement for connecting a multiplicity of optical waveguides has an array of connections as well as at least one optical cable, which contains one and only one core having a plurality of first optical waveguides. The core and the cable each have a round cross section. At least one of a multiplicity of further optical waveguides is or are fixed in each case one of the connections. The optical cable is designed to produce an optical connection between a first and a second of the connections.

The first and/or second of the connections preferably comprise(s) a plug connection element for making a plug-in optical connection between optical waveguides. A plug-in optical connection between optical waveguides is normally made by a pair of plug connection elements, in each of which one of the optical waveguides that are to be optically coupled is fixed. The plug connection elements in the pair can be mechanically coupled such that end surfaces of the optical waveguides to be optically coupled are opposite one another, thus allowing light to pass over from one optical waveguide to the other. A plug connection can normally be disconnected and connected again several thousand times before the pair of plug connection elements used for this purpose becomes worn. A pair of plug connection elements may comprise a plug and a socket. The plug connection elements in a pair may, however, also be designed to be identical.

The plug connection element of the first and/or second of the connections may be designed to produce one and only one optical connection. One and only one of the further optical waveguides is then fixed in the plug connection element.

The plug connection element of the first and/or second of the connections may be designed to produce a plurality of optical connections between two optical waveguides in each case. A plurality of the further optical waveguides are then fixed in the plug connection element. In particular, the same number of first optical waveguides as the number of further optical waveguides can be fixed in the plug connection element.

One of the further optical waveguides which is fixed in the first and/or second of the connections may also be welded to in each case one of the first optical waveguides in the optical cable. This allows the optical cable to be firmly connected to the first and/or second of the connections, thus saving the space for the plug connection elements.

A first group of further optical waveguides is preferably coupled to a common optical waveguide via an optical distributor. Optical signals can be interchanged between the common optical waveguide and the further optical waveguides in the first group. The optical waveguides in the first group thus each receive the same optical signal. One of the further optical waveguides in the first group is connected to the first of the connections.

The method according to the invention for production of an optical cable comprises a plurality of steps. First, an optical cable is provided which has one and only one core, containing a plurality of first optical waveguides. The cable and the one and only one core each have a round cross section.

The first optical waveguides are exposed at least one end of the cable. A first and a second of a multiplicity of further optical waveguides are each optically coupled via in each case one of the first optical waveguides. The round cross section of the cable and of the core means that the cable is highly flexible, independently of the direction. The high flexibility allows a jumper panel to be wired virtually independently of the relative position of the plurality of first and second connections.

By way of example, the optical cable is produced by the first optical waveguides being supplied to a production line where they are surrounded by a core sleeve in order to form the core. The core is surrounded by a first strain-relief arrangement and the cable sheath. The first strain-relief arrangement generally has strain-relief elements in the form of threads. Since the core sleeve is arranged between the plurality of optical waveguides and the strain-relief elements, the plurality of optical waveguides and the strain-relief elements can be held separately, and can easily be removed successively during the prefabrication of the cable.

A jumper panel is preferably wired by providing a cable whose core has a core sleeve with a low elongation at tear, and whose first strain-relief arrangement is arranged between the core sleeve and the cable sheath. A section of the cable sheath is removed at one end of the optical cable in order to expose the first strain-relief arrangement. A section of the first strain-relief arrangement is then removed, in order to expose the core sleeve. A section of the core sleeve is then removed, in order to expose the first optical waveguides. Since the core sleeve has a low elongation at tear, the optical cable can be prefabricated without the use of tools once the cable sheath has been removed.

The optical cable can be provided with a connecting apparatus for wiring of a jumper panel. The connecting apparatus is designed to produce an optical connection to in each case one of the first optical waveguides. The connecting apparatus may have a first plug connection element in order to produce a plurality of plug-in optical connections. The connecting apparatus may also have a plurality of second plug connection elements in order to produce in each case one individual plug-in optical connection.

The first optical waveguides are introduced into the connecting apparatus. The connecting apparatus is then attached to the first strain-relief arrangement, so that mechanical stresses which are introduced via a connecting apparatus can be absorbed by the first strain-relief arrangement.

### BRIEF DESCRIPTION OF THE FIGURES

FIGS. 1A and 1B show the cross section of one embodiment of the optical cable according to the present invention.

FIGS. 2A and 2B show preferred embodiments of the optical cable according to the present invention.

FIG. 3 shows a jumper panel and the optical connections made by the cable according to the present invention.

FIGS. 4A and 4B show an embodiment of the arrangement according to the present invention.

### DESCRIPTION OF THE INVENTION

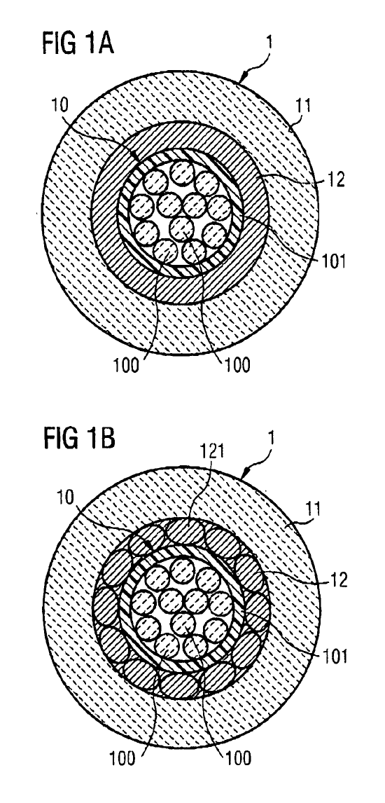

FIGS. 1A and 1B show one exemplary embodiment of an optical cable according to the invention, in the form of a cross section. The optical cable 1 is a multi-fiber cable (MFC). The first optical waveguides 100 are surrounded by the cable sheath 11. The first optical waveguides 100 may be of different colors. An appropriate number of different colors may be used in order to distinguish between a total number of 2 to 12 of the first optical waveguides 100. Different colors can be used in conjunction with ring signatures in order to distinguish between a total number of 13 to 24 of the first optical waveguides 100. In the case of a single fiber cable or a ribbon cable, in contrast, one individual optical waveguide is in each case surrounded by one sleeve.

The use of the optical cable 1 for wiring a jumper panel occupies less space than the use of single fiber cables or ribbon cables for wiring. For example, a total of 12 single fiber cables can be replaced by the optical cable 1, whose core 10 contains a total of 12 first optical waveguides 100. A core with more than one optical waveguide is also referred to as a bundle core. The optical cable 1 has an external diameter of, for example, 2.8 mm, corresponding to the external diameter of a single fiber cable. In contrast to a ribbon cable, the optical cable 1 has no preferred bending direction. The minimum bending radius of the optical cable 1 is thus independent of the bending direction. Furthermore, the optical cable 1 occupies less space than a ribbon cable in which each individual optical waveguide is surrounded by a sleeve. The external contours of the core sleeve of the core and of the cable sheath, and hence the entire cable, each have a round cross section, in particular a circular cross section. The circular cross section avoids any preferred bending plane. The optical waveguides or optical fibers which are located in the core are arranged loosely and comprise just the bare fibers. The fibers are not buffered. The fibers contain the glass that carries the light as well as the cladding layer, and a polymer coating, but no further protective sleeve. In contrast to this, buffered fibers also have a further protective sleeve surrounding the cladding layer.

The cable sheath 11 is preferably composed of polyethylene or polyurethane. It is desirable for a sheath material to have flame-retardant and corrosion-resistance characteristics. Preferred sheath materials are FRNC (Flame-Retardant Non-Corrosive) or LSZH (Low-Smoke Zero-Halogen). These may be polyethylene or polyurethane material with additives incorporated in them, such as sodium hydroxide or magnesium hydroxide, which additives provide the FRNC or LSZH characteristics. The cable sheath 11 preferably has a thickness of 0.5 mm.

The core 10 of the optical cable preferably has a core sleeve which surrounds the first optical waveguides and has a low elongation at tear. A low elongation tear can be achieved by a thin wall and by the use of a suitable material for the core sleeve 101. By way of example, the core sleeve material may contain a polymer, for example ethyl-vinyl acetate, poly-vinyl chloride or a thermoplastic elastomer (TPE), having an additive or filler embedded therein. The use of chalk as the additive reduces the elongation at tear of the core sleeve 101. The core sleeve 101 has a thickness, for example, of between 0.1 mm and 0.2 mm. A core sleeve such as this can also be removed over relatively long lengths easily, quickly and without any tools. Furthermore, the optical cable can be prefabricated in essentially the same way as a single fiber cable.

The core 10 of the optical cable also has a dry internal area. In particular, the internal area is free of any filling compound, for example a thixotropic gel. This simplifies the prefabrication of the optical cable 1, because no filling compound can drip out. The optical cable 1 can thus be used as an inner cable. Furthermore, the optical characteristics of the first optical waveguides 100 are not influenced by the prefabrication process.

The first optical waveguides 100 are longer than the cable sheath 11, that is to say sections of the first optical waveguides 100 which are somewhat longer run in a section of the cable sheath 11 which has a specific length. This allows the optical cable 1 to be bent or rotated without the first optical waveguides 100 being subjected to excessive mechanical tensile or compressive stresses. The optical cable 1 is thus more flexible and has a smaller bending radius than a single fiber cable. The required excess length can be produced in particular by twisting (i.e., stranding) of the first optical waveguides 100.

A first strain-relief arrangement 12 can be formed between the core 10 and the cable sheath 11. The first strain-relief arrangement 12 may, for example, contain aramide. The first strain-relief arrangement 12 may, in particular, have a plurality of strain-relief elements 121 in the form of strands, which are arranged distributed uniformly around the core 10. The strain-relief elements 121 may, for example, contain aramide yarns.

The first optical waveguides 100, which are arranged in the core 10 of the optical cable 1, may each be designed to carry one or more optical modes. If one of the first optical waveguides 100 is designed to carry a single optical mode, then it has an inner area with a higher refractive index, and an outer area with a lower refractive index. The refractive indexes of the inner and outer areas are each independent of the location. The diameter of the inner area is typically less than 10 micrometres. If one of the first optical waveguides 100 is designed to carry a plurality of optical modes, then the refractive index in the inner area has a cross-sectional profile which is dependent on the location. The refractive index of the inner area decreases continuously as the radius increases, and merges continuously at the boundary between the inner area and the outer area into the refractive index of the outer area, which is independent of the location.

The optical cable 1 is produced by a process which has a plurality of steps. First of all, the first optical waveguides 100 are supplied to a core line. The first optical waveguides 100 are surrounded by the core sleeve 101 in the core line. A core sleeve 101 is normally extruded around the plurality of optical waveguides 100, using a material with a low elongation at tear. The first optical waveguides 100 are twisted with one another or are laid loosely in the core sleeve 101, in order to ensure that the first optical waveguides 100 are longer than the core sleeve 101. The core 10 that is produced in the core line in this way is supplied to a sheath line. In the sheath line, the strain-relief arrangement 12 and the cable sheath 11 are formed around the core 10. The steps which are carried out in the sheath line are known from conventional processes for production of single fiber cables.

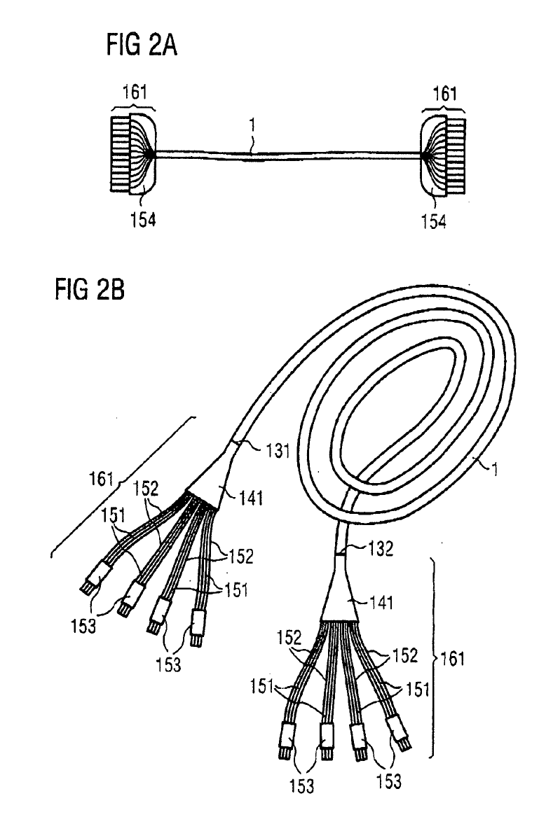

FIGS. 2A and 2B show one preferred exemplary embodiment of an optical cable according to the invention, in the form of a perspective view. The optical cable 1 in the cross-sectional view in each case has the configuration described with reference to FIG. 1. At both of its ends, the optical cable 1 has, in particular, in each case one connecting apparatus 161, which is attached to the first strain-relief arrangement 12.

In the exemplary embodiment illustrated in FIG. 2A, the connecting apparatus 161 has a first plug connection element 154 in order to produce a plurality of plug-in optical connections. The first plug connection element 154 may, for example, have a rigidly connected duplex or more generally multiplex arrangement comprising plug connectors to the ST or SC Standard. The plurality of first optical waveguides 100 in the optical cable 1 are guided and fixed within the first plug connection element 154 for example by small tubes (ferrules) composed of ceramic or stainless steel.

In the exemplary embodiment illustrated in FIG. 2B, the connecting apparatus 161 has a connecting element 141, a plurality of connecting fibers (pigtails), which each have a second optical waveguide 151 and a second strain-relief arrangement 152 surrounding it, and a plurality of second plug connection elements 153, which are each designed to produce a single plug-in optical connection.

The second optical waveguide 151 is, for example, optically coupled via a spliced joint to one of the first optical waveguides 100. The second connecting elements 153 are attached to the second strain-relief arrangement 152. The second plug connection elements 153 may, for example, be single plug connectors to the ST or SC Standard. One of the second optical waveguides 151 is in each case inserted into one of the second plug connection elements 153 and is guided and fixed in it, for example by means of a small tube (ferrule) composed of ceramic or stainless steel. The second strain-relief arrangements 152 for the second optical waveguides 151 are also held on the plug connection elements 153 in order to allow tensile stresses introduced via them to be absorbed.

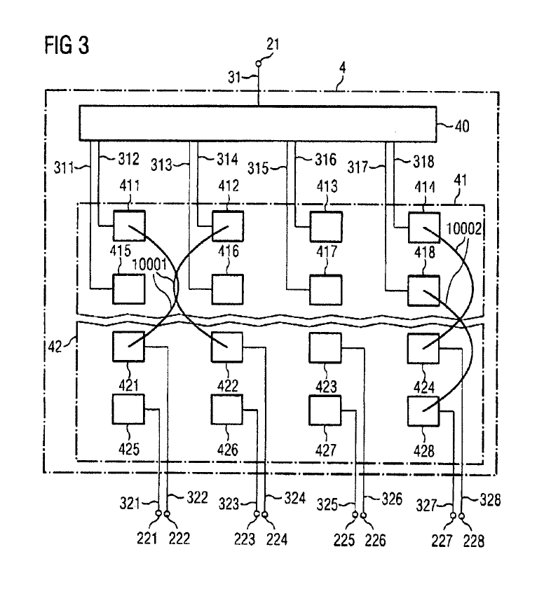

FIG. 3 shows one exemplary embodiment of wiring according to the invention for a jumper panel. The jumper panel 4 is arranged in a distribution cabinet. The jumper panel 4 is connected to the network 21 via the optical waveguides 311-318. The jumper panel 4 is connected to the peripherals 221-228 via the optical waveguides 321-328. In particular, the network 21 is a communication network such as a telephone network or a data network. In particular, the peripherals 221-228 have a number of connecting sockets for terminals, for example computers.

The jumper panel 4 has the first connecting poles 411-418, which are arranged in a first section 41, and the second connecting poles 421-428, which are arranged in a second section 42. One of the optical waveguides 311-318 is fixed in a respective one of the first connecting poles 411-418. One of the optical waveguides 321-328 is fixed in a respective one of the second connecting poles 421-428. The optical waveguides 311-318 are connected to the optical distributor 40. The optical distributor 40 is connected to the network 21 via the optical waveguide 31. The optical waveguides 321-328 are connected to the peripherals 221-228.

When an optical connection is produced between one of the first connecting poles 411-418 and one of the second connecting poles 421-428, then signals can be interchanged between the network 21 and the peripherals 221-228 via this optical connection. For example, the second connecting poles 421 and 422 or the second connecting poles 424 and 428 can each be connected to two connecting sockets which are arranged in the same area. The connecting sockets in the respective areas can then be connected to the network 21 by producing the optical connections 10001 or 10002 via respective optical cables 1 according to the invention between the first connecting poles 411 and 412, as well as 414 and 418, respectively, and the second connecting poles 421 and 422, as well as 424 and 428, respectively.

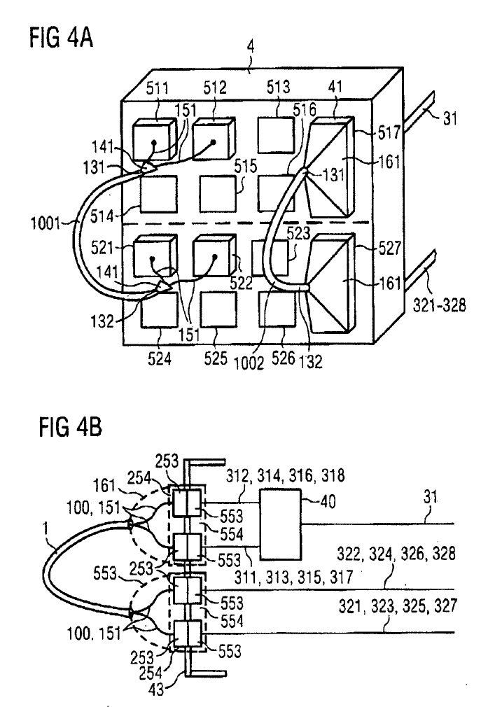

FIGS. 4A and 4B show exemplary embodiments of an arrangement according to the invention for connection of a multiplicity of optical waveguides. The jumper panel 4 has the two sections 41 and 42, which are linked to one another via different versions 1001 and 1002 of the optical cable 1 according to the invention. The connecting poles 411-418 and 421-428 are thus arranged in the sections 41 and 42 as described with reference to FIG. 3. The reference symbols 411-418 and 421-428 have, however, been omitted from FIGS. 4A and 4B, for the sake of clarity. The connections 511-517 and 521-527 respectively have one and only one of the respective connecting poles 411-418 and 421-428. The respective connections 511-516 and 521-526 each have one and only one of the respective connecting poles 411-413 and 415-417, as well as 421-423 and 425-427. The respective connections 517 and 527 have the respective two connecting poles 414 and 418, as well as 424 and 428.

On the rear face of the front panel 43, the optical waveguides 311-318 which are connected to the network 21 are supplied to the connecting poles 411-418 arranged in the first section 41, and the optical waveguides 321-328 which are connected to the peripherals 211-218 are supplied to the connecting poles 421-428 arranged in the second section 42. On the front face of the front panel 43, the optical cable 1 connects a plurality of the first connecting poles 411-418 to a plurality of the second connecting poles 421-428. In this case, the optical connection between in each case one of the first connecting poles 411-418 and a respective one of the second connecting poles 421-428 is produced via one of the plurality of optical waveguides 100 in the optical cable 1.

By way of example, the versions 1001 and 1002 of the optical cable 1 each connect to one another two selected ones of the first connecting poles 411-418 and two selected ones of the second connecting poles 421-428. However, in a relatively large jumper panel, it would also be possible, for example, for 12 selected first connecting poles and 12 selected second connecting poles to be connected to one another via the optical cable 1.

The version 1001 of the optical cable 1 has plug connection elements 153 which are each designed to produce a plug-in connection to a plug connection element 253 for the connections 511-513, 515-517, 521-523 and 525-527. The version 1002 of the optical cable 1 has plug connection elements 154 which are each designed to produce a plug-in connection to a plug connection element 254 for the connections 517 and 527.

The pair of plug connection elements 154 and 254 are designed to produce two plug-in optical connections. The pair of plug connection elements 154 and 254 may, however, also be designed to produce a greater number of optical connections.

It is also feasible to provide a multi-fiber cable at in each case one end with a connecting apparatus 161 which has a plurality of plug connection elements which are each designed to produce a plurality of optical connections. By way of example, a 12-fiber cable can be used as a jumper cable in a jumper panel with an arrangement of connections for triple plug connecting apparatus at one end which has 4 plug connection elements which are each designed for triple plug connections.

We claim:

1. The optical cable, comprising
a cable sheath,
one and only one core, comprising a core sleeve and a plurality of first optical waveguides which are contained within the core sleeve, with the core sleeve being formed from a polymer material filled with an additive, and with the cable sheath surrounding the core sleeve,
with the optical cable and one and only one core each having a round cross section, and with the optical cable being designed to produce an optical connection between further optical waveguides.

2. The optical cable according to claim 1, wherein the polymer material contains an ethyl-vinyl acetate or a polyvinyl chloride, or a thermoplastic elastomer, or a combination of at least two thereof.

3. The optical cable according to any of claims 1, wherein the cable sheath is composed of polyethylene or polyurethane, and is designed to have a flame-retardant characteristic or a low-smoke, zero-halogen characteristic.

4. The optical cable according to claim 2, wherein the core sleeve surrounds a dry internal area.

5. The optical cable according to any of claims 1, wherein the plurality of first optical waveguides are longer than the cable sheath.

6. The optical cable according to any of claims 1, wherein the plurality of first optical waveguides are twisted with one another.

7. The optical cable according to any of claims 1, wherein a first strain-relief arrangement is formed between the core and the cable sheath.

8. The optical cable according to claim 7, wherein the first strain-relief arrangement has a plurality of strands, which are arranged distributed uniformly around the core.

9. The optical cable according to any of claims 1, which has a connecting apparatus at a first end and/or at a second end.

10. The optical cable according to claim 7, which has a connecting apparatus, which is attached to the first strain-relief arrangement, at a first end and/or at a second end.

11. The optical cable according to claim 9, wherein the connecting apparatus is designed to produce a plurality of plug-in optical connections, and in which at least two of the plurality of first optical waveguides are fixed in the connecting apparatus.

12. The optical cable according to claim 9, wherein the connecting apparatus has:
a connecting element which is attached to the first strain-relief arrangement,
a plurality of second optical waveguides, which are each optically coupled to one of the plurality of first optical waveguides,
a plurality of second strain-relief arrangements, which each surround one of the second optical waveguides and are attached to the first connecting element.

13. The optical cable according to claim 12, wherein the second optical waveguide is welded to said one of the plurality of first optical waveguides.

14. The optical cable according to any of claims 12, wherein the at least one connecting fiber has a second connecting element which is attached to the second strain-relief arrangement.

15. The optical cable according to claim 14, wherein the second connecting element is in the form of a plug connector in order to produce a plug connection between the second optical waveguides and the further optical waveguides, with the second optical waveguide being guided and fixed in the second connecting element.

16. The optical cable according to any of claims 1, which has a total number of 2 to 24 first optical waveguides.

17. The optical cable according to any of claims 1, wherein at least one of the plurality of first optical waveguides is designed to carry one optical mode.

18. The optical cable according to any of claims 1, wherein at least one of the plurality of first optical waveguides is designed to carry a plurality of optical modes.

19. The optical cable according to any of claims 1, which cable has an external diameter of less than or equal to 3.0 mm and a total of 2 to 12 of the first optical waveguides, or an external diameter of less than or equal to 3.5 mm and a total of 13 to 24 of the first optical waveguides.

20. The optical cable according to any of claims 1, having twelve optical fibers, which are contained in the one and only one core, and having an external diameter of the cable sheath of approximately 2.8 millimetres.

21. An arrangement for connecting a multiplicity of optical waveguides, comprising:
an array of connections in each of which at least one of a multiplicity of further optical waveguides is or are fixed,
an optical cable which contains one and only one core with a plurality of optical waveguides, with the cable and the one and only one core each having a round cross section,
with the optical cable being designed to produce an optical coupling between a first and a second of the connections.

22. The arrangement according to claim 21, wherein the first and/or the second of the connections has a plug connection element for production of a plug-in optical connection.

23. The arrangement according to claim 22, wherein the plug connection element of the first and/or of the second of the connections is designed to produce one and only one optical connection.

24. The arrangement according to claim 22, wherein the plug connection element of the first and/or of the second of the connections is designed to produce a plurality of optical connections.

25. The arrangement according to claim 21, wherein one of the further optical waveguides which is fixed in the first and/or in the second of the connections is welded to in each case one of the first optical waveguides of the optical cable.

26. The arrangement according to any of claims 21, wherein a first group of the further optical waveguides is connected via an optical distributor to a common optical waveguide.

27. A method for connecting a multiplicity of optical waveguides, comprising the steps of:
providing an optical cable which contains one and only one core with a plurality of optical waveguides, with the cable and the one and only one core each having a round cross section, according to one of claims 1 to 7,
providing an array of connections, to each of which at least one of a multiplicity of further optical waveguides is supplied,
exposing the plurality of optical waveguides at ends of the optical cable,
connecting at least a first to at least a second from the multiplicity of further optical waveguides via in each case one of the plurality of optical waveguides.

28. The method according to claim 27, wherein the step of providing the optical cable comprises provision of an optical cable having a strain-relief arrangement, which is arranged between the core sleeve and the cable sheath, and has the following steps:
removing a section of the cable sheath in order to expose the strain-relief arrangement,
removing a section of the strain-relief arrangement in order to expose the core sleeve,
removing a section of the core sleeve in order to expose the plurality of optical waveguides.

29. The method according to claim 28, comprising the steps of:
providing a connecting apparatus, introducing the plurality of optical waveguides into the connecting apparatus,
attaching the connecting apparatus to the strain-relief arrangement.
